(19) United States
(12) Patent Application Publication
(10) Pub. No.: US 2015/0128270 A1
(43) Pub. Date: May 7, 2015

(54) INTELLIGENT WIRELESS INVASION PREVENTION SYSTEM AND SENSOR USING CLOUD SENSOR NETWORK

(71) Applicant: Konic Glory Co., Ltd., Seoul (KR)

(72) Inventors: Nick Lee, Seongnam (KR); Jaebok Lee, Yongin (KR)

(21) Appl. No.: 14/401,284

(22) PCT Filed: May 8, 2013
(86) PCT No.: PCT/KR13/04037

§ 371 Date: Nov. 14, 2014

(30) Foreign Application Priority Data
May 15, 2012 (KR) 1020120051690

(51) Int. Cl. H04L 29/06; H04W 12/08

(52) U.S. Cl. CPC H04L 63/1416; H04W 12/08
USPC 726/23

(57) ABSTRACT

A wireless intrusion prevention system, according to one embodiment of the present invention, comprises: a first group comprising at least one first sensor and at least one first authorized wireless LAN equipment; a second group comprising at least one second sensor and at least one second authorized wireless LAN equipment; and a management server for managing the at least one first sensor and the at least one second sensor, wherein the first sensor detects the occurrence of an event from an unauthorized wireless LAN equipment and transmits a first broadcast signal on the occurrence of the event to the other first sensors in the first group and the at least one second sensor.

### TECHNICAL FIELD

The present invention relates to an intelligent wireless invasion prevention system and sensor using a cloud sensor network.

### BACKGROUND OF ART

A wireless network is weak in security, compared with a wire network. Therefore, wireless invasion prevention technology that detects and intercepts a security threat event occurring from an unauthorized wireless Local Area Network (LAN) device is required.

According to a general wireless invasion prevention system, a sensor detects an event and transmits the event to a management server. Even when a plurality of sensors detect the same event, each sensor transmits the same event to the management server. As the management server repeatedly receives the same event, a load may occur and unnecessary traffic may exist. Further, as a plurality of sensors that detect an illegal connection interception signal overlappingly occur, an unnecessary wireless resource is consumed.

Accordingly, it is requested to minimize an interception signal and traffic between the sensor and the management server. It is requested to efficiently track a location at which an event has occurred.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide an intelligent wireless invasion prevention system and sensor using a cloud sensor network.

### Technical Solution

An exemplary embodiment of the present invention provides a wireless invasion prevention system including: a first group including at least one first sensor and at least one first authorized wireless Local Area Network (LAN) device; a second group including at least one second sensor and at least one second authorized wireless LAN device; and a management server that manages the at least one first sensor and the at least one second sensor, wherein the first sensor detects event occurrence from an unauthorized wireless LAN device and transmits a first broadcast signal of the event occurrence to the remaining first sensors within the first group and the at least one second sensor.

The first sensor may detect the event occurrence using a Medium Access Control (MAC) address that is included in a signal that is received from the unauthorized wireless LAN device.

The first sensor may include: a transmitting and receiving unit that transmits the first broadcast signal and that receives a second broadcast signal of an event that has occurred from the unauthorized wireless LAN device from at least one of the remaining first sensors and the at least one second sensor; and a sensor-in-charge determining unit that compares the first broadcast signal and the second broadcast signal and that determines a sensor in charge of the event.

The first broadcast signal or the second broadcast signal may include at least one of identification information of the first sensor or the second sensor, strength of a signal that is received from the unauthorized wireless LAN device, a detection time point of event occurrence, and an MAC address and an event kind of the unauthorized wireless LAN device.

The sensor-in-charge determining unit may determine a sensor in charge based on at least one of strength of the signal, the number of sensors, having detected the same event within a group, and the detection time point.

The first sensor may further include a group determining unit that determines an event occurrence group based on at least one of strength of a signal that is received from the unauthorized wireless LAN device or the number of sensors, having detected the same event within a group.

The first sensor may further include a distance estimation unit that estimates a distance between the first sensor and the unauthorized wireless LAN device based on strength of a signal that is received from the at least one first authorized wireless LAN device.

The distance estimation unit may store at least one distance table according to strength of a signal that is received from the at least one first authorized wireless LAN device and estimate a distance between the first sensor and the unauthorized wireless LAN device using strength of a signal that is received from the unauthorized wireless LAN device and the distance table.

The first sensor may further include a self-interception unit that self-detects and intercepts occurrence of an event, when communication with the management server is disconnected.

The management server may instruct to change a sensor in charge to the remaining sensors, when detecting that operation of the sensor in charge is stopped.

The first sensor may determine a new sensor in charge according to strength of a signal that is received from the unauthorized wireless LAN device or a detection time point of event occurrence, when operation of the sensor in charge is stopped.

Another embodiment of the present invention provides a sensor including: an event detection unit that detects event occurrence from an unauthorized wireless Local Area Network (LAN) device; a transmitting and receiving unit that transmits a first broadcast signal of the event occurrence to other sensors and that receives a second broadcast signal of the event occurrence from the other sensors; a sensor-in-charge determining unit that compares the first broadcast signal and the second broadcast signal to determine a sensor in charge to intercept an event; and an event interception unit that intercepts the event.

The first broadcast signal or the second broadcast signal may include at least one of identification information of a sensor that transmits the first broadcast signal or the second broadcast signal, strength of a signal that is received from the unauthorized wireless LAN device, a detection time point of event occurrence, and a Medium Access Control (MAC) address and an event kind of the unauthorized wireless LAN device.

The sensor may belong to a predetermined group that is separated on space, and the sensor-in-charge determining unit may determine a sensor in charge based on at least one of strength of the signal, the number of sensors, having detected the same event within a group, and the detection time point.

The sensor may belong to a predetermined group that is separated on space, and the sensor may further include a group determining unit that determines an event occurrence group based on at least one of strength of the signal or the number of sensors, having detected the same event within a group.

The sensor may further include a distance estimation unit that estimates a distance between the sensor and the unauthorized wireless LAN device based on strength of a signal that is received from at least one authorized wireless LAN device and strength of a signal that is received from an unauthorized wireless LAN device.

### Advantageous Effects

According to an exemplary embodiment of the present invention, traffic between a sensor and a management server can be reduced. After an event occurs, a delay time until intercepting the event can be minimized. Because a load of a management server can be reduced, the number of sensors in which the management server manages can be maximized. Further, a space or a location in which an event has occurred can be efficiently tracked.

### BRIEF DESCRIPTION OF DRAWINGS

FIG. 1 is a diagram illustrating a wireless invasion prevention system according to an exemplary embodiment of the present invention.

FIG. 2 is a block diagram illustrating a configuration of a sensor 10 according to an exemplary embodiment of the present invention.

FIG. 3 is a flowchart illustrating a method of determining a sensor in charge of a sensor according to an exemplary embodiment of the present invention.

FIG. 4 is a flowchart illustrating a method of determining a group in which an event from an unauthorized AP occurs according to an exemplary embodiment of the present invention.

FIG. 5 is a flowchart illustrating a method of changing a sensor according to an exemplary embodiment of the present invention.

FIG. 6 is a flowchart illustrating a method of estimating a distance according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in an entire specification, unless explicitly described to the contrary, the word “comprise” and variations such as “comprises” or “comprising”, will be understood to imply the inclusion of stated elements but not the exclusion of any other elements.

Further, a term “ . . . unit” described in the specification indicates a unit that processes at least one function or operation and may be implemented with hardware, software, or a combination of hardware and software.

In this specification, a terminal may indicate a Mobile Station (MS), a Mobile Terminal (MT), a Subscriber Station (SS), a Portable Subscriber Station (PSS), a User Equipment (UE), and an Access Terminal (AT) and may include an entire function or a partial function of the MS, the MT, the SS, the PSS, the UE, and the AT.

In this specification, a wireless LAN device constitutes a wireless network and exchanges data with other wireless LAN devices through a wireless network. The wireless LAN device may include, for example, an Access Point (AP), a wired and wireless Internet Protocol (IP) sharer, a wireless LAN card, a wireless printer, an antenna, and a wireless network camera.

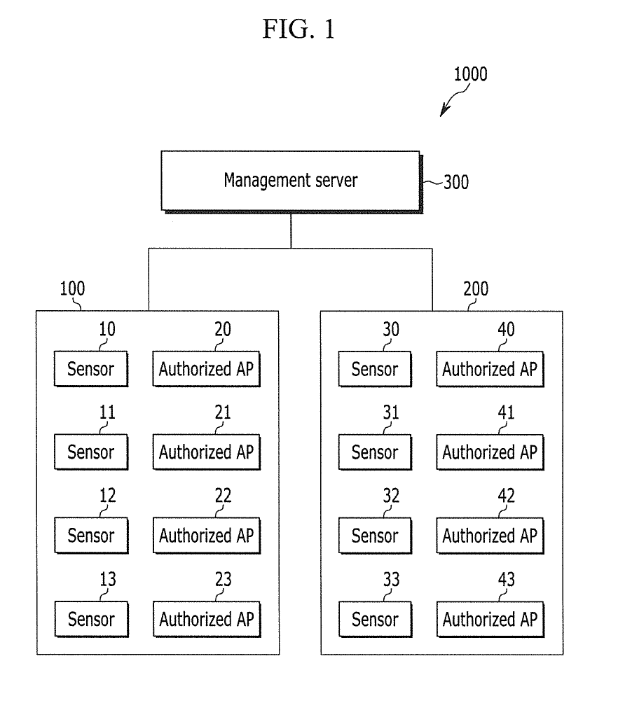

FIG. 1 is a diagram illustrating a wireless invasion prevention system according to an exemplary embodiment of the present invention.

Referring to FIG. 1, a wireless invasion prevention system 1000 includes a group 100 including at least one sensor 10, 11, 12, and 13 and at least one authorized wireless LAN device (hereinafter, may be used as an authorized AP) 20, 21, 22, and 23, a group 200 including at least one sensor 30, 31, 32, and 33 and at least one authorized AP 40, 41, 42, and 43, and a management server 300. The sensors 10, 11, 12, 13, 30, 31, 32, and 33 detect and intercept an event from an unauthorized wireless LAN device. The management server 300 manages sensors that are included in the group 100 and the group 200.

The group 100 and the group 200 may be classified according to a located space of a sensor and an authorized AP. That is, a sensor and an authorized AP that are located at the same space may be classified into one group. For example, when the management server 300 manages sensors of several floors within a building, the management server 300 may separate a group of a sensor and an authorized AP on a floor basis. That is, a sensor and an authorized AP that are located at a first floor may be combined into one group, and a sensor and an authorized AP that are located at a second floor may be combined into another group.

According to an exemplary embodiment of the present invention, when a sensor detects an event that has occurred from an unauthorized wireless LAN device (hereinafter, may be used as an unauthorized AP), the sensor broadcasts event information to other sensors. Here, an unauthorized AP may indicate an illegal invader, an illegal user, and an attacker. Each sensor determines a sensor in charge of a specific event using an event that is detected by the each sensor and event information that is received from other sensors, and the sensor in charge intercepts a corresponding event.

Hereinafter, the wireless invasion prevention system 1000 according to an exemplary embodiment of the present invention will be described in detail.

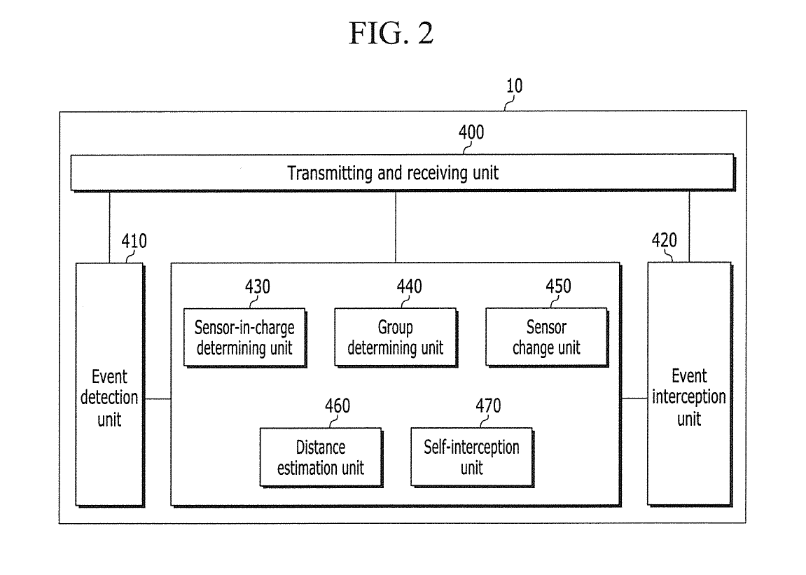

FIG. 2 is a block diagram illustrating a configuration of a sensor 10 according to an exemplary embodiment of the present invention.

Referring to FIG. 2, the sensor 10 includes a transmitting and receiving unit 400, an event detection unit 410, an event interception unit 420, a sensor-in-charge determining unit 430, a group determining unit 440, a distance estimation unit 440, a sensor change unit 450, and a self-interception unit 460.

When the transmitting and receiving unit 400 detects an event that has occurred from an unauthorized AP, the transmitting and receiving unit 400 transmits a broadcast signal of the event to other sensors. Here, other sensors may include sensors 30, 31, 32, and 33 within the other group 200 as well as other sensors 11, 12, and 13 within the group 100 to which the other sensors belong. The transmitting and receiving unit 400 receives a broadcast signal of an event that has occurred from an unauthorized AP from other sensors.

The event detection unit 410 detects an event that has occurred from an unauthorized AP. The event detection unit 410 may detect an event using a Medium Access Control (MAC) address that is included in a signal that is received by the sensor 10. For example, when a MAC address that is included in a signal that is received by the sensor 10 is not a MAC address of an authorized AP, the event may be estimated as an event that has occurred from the unauthorized AP.

The event interception unit 420 intercepts an event that has occurred from the unauthorized AP. For this purpose, the sensor 10 may determine a sensor in charge on an event basis.

The sensor-in-charge determining unit 430 determines a sensor in charge that detects or intercepts a specific event (Active Decision). The sensor-in-charge determining unit 430 may determine a sensor in charge using at least one of strength of a signal that is received from an unauthorized AP, the number of sensors, having detected the same event within a group, and an event detection time point.

The group determining unit 440 determines a corresponding location of a group in which an event from an unauthorized AP has occurred (Group Decision). The group determining unit 440 may determine an event occurrence group based on at least one of strength of a signal that is received from an unauthorized AP or the number of sensors, having detected the same event within a group.

When a sensor in charge of a specific event stops to operate, the sensor change unit 450 changes a sensor in charge of a corresponding event (Change over). When the sensor change unit 450 receives a sensor change instruction from the management server 300 or when a sensor existence determination signal that should periodically receive from a sensor in charge does not arrive for a predetermined time, the sensor change unit 450 may perform a procedure for a sensor change by self-determination.

The distance estimation unit 460 estimates a distance between a sensor and an unauthorized AP (Attenuation To Distance). For this purpose, the distance estimation unit 460 stores distance information according to strength of a signal receiving from an authorized AP. The distance estimation unit 460 may estimate a distance between a sensor and an unauthorized AP from strength of a signal receiving from the unauthorized AP.

When communication with the management server 400 is disconnected, the self-interception unit 470 detects and self-intercepts an event from an unauthorized AP (Stand Alone Operation).

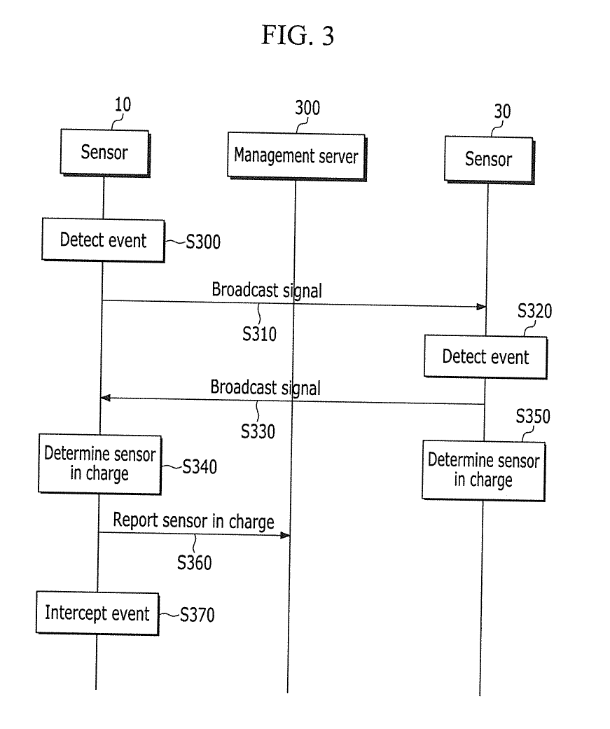

FIG. 3 is a flowchart illustrating a method of determining a sensor in charge of a sensor according to an exemplary embodiment of the present invention. For better comprehension and ease of description, the sensor 10 and the sensor 30 belonging to different groups are illustrated, but a method of determining a sensor in charge may be equally applied to sensors belonging to the same group.

Referring to FIG. 3, when the sensor 10 and the sensor 30 detect an event that has occurred from an unauthorized AP (S300 and S320), the sensor 10 and the sensor 30 transmit a broadcast signal of event occurrence to other sensors (S310 and S330). That is, the sensor 10 transmits a broadcast signal notifying event occurrence to the sensors 30, 31, 32, and 33 of the other group 200 as well as other sensors 11, 12, and 13 of the group 100 to which the sensor 10 belongs. The sensor 30 transmits a broadcast signal notifying event occurrence to sensors 10, 11, 12, and 13 of the other group 100 as well as other sensors 31, 32, and 33 of the group 200 to which the sensor 30 belongs. Table 1 is an example of a packet format of a broadcast signal.

TABLE 1

| | | | | | | | | | | Signal |
|---|---|---|---|---|---|---|---|---|---|---|
| | Detec- | Packet | | Sensor | | Station | Frame | Sub | Source | inten- |
| Division | tion time | type | Event ID | ID | AP MAC | MAC | type | type | MAC | sity |
| Size | 8 | 2 | 2 | 2 | 8 | 8 | 1 | 1 | 8 | 2 |
| (bytes) | | | | | | | | | | |

In this way, the broadcast signal may include a detection time of an event, a packet type, an event kind (event ID), identification information of a sensor (sensor ID), an MAC address of an unauthorized AP (AP MAC), a station MAC, a frame type, a sub-type, a source MAC, and strength of a signal that is received from an unauthorized AP (signal intensity).

The sensor 10 and the sensor 30 compare a transmitted broadcast signal and a received broadcast signal and determine a sensor in charge of an event (S340 and S350). For this purpose, the sensor 10 or the sensor 30 compares an event kind that is included in a transmitted broadcast signal and an event kind that is included in a received broadcast signal, and when an event kind is the same, the sensor 10 or the sensor 30 may temporarily store information that is included in the received broadcast signal. After a predetermined time period has elapsed, the sensor 10 or the sensor 30 may determine a sensor in charge using at least one of strength of a signal that is received from an unauthorized AP that is included in the broadcast signal, the number of sensors, having detected the same event within a group, and a detection time point of an event. For example, the sensor 10 or the sensor 30 may determine a sensor in which strength of a signal that is received from an unauthorized AP is largest as a sensor in charge. When strength of a signal that is received from the unauthorized AP is the same, a sensor within a group in which the number of sensors, having detected a corresponding event is largest may be determined as a sensor in charge. When strength and a group of a signal that is received from an unauthorized AP are the same, a sensor in which a detection time of an event is fastest may be determined as a sensor in charge. In another example, by applying a weight value to strength of a signal that is received from an included unauthorized AP, the number of sensors, having detected the same event within a group, and a detection time point of an event, a sensor in charge may be determined.

When the sensor 10 is determined as a sensor in charge, the sensor 10 reports to the management server 300 that the sensor 10 is a sensor in charge of a corresponding event (S360) and performs an event interception procedure (S370).

Although not shown in the drawing, while the sensor 10 performs an event interception procedure, when the sensor 10 receives a broadcast signal of the same event from other sensors, the sensor 10 may notify a sensor, having transmitted the broadcast signal that the sensor 10 is a sensor in charge. Accordingly, a procedure in which a sensor, having newly detected the same event determines a sensor in charge or a procedure in which a sensor, having newly detected the same event reports to a management server can be prevented from being overlappingly performed.

Although not shown in the drawing, when the sensor 30 detects an event, the sensor 30 may report event detection to the management server 300. However, when the sensor 30 receives a broadcast signal of event occurrence from another sensor 10, the sensor 30 may not report event detection to the management server 300. In this way, even when a plurality of sensors detect the same event, by minimizing the number that reports event detection to the management server 300, traffic waste between the management server 300 and the sensor can be prevented.

Hereinafter, a method of determining a corresponding location of a group in which an event from an unauthorized AP occurs will be described. It is assumed that a process of S300 to S330 of FIG. 3 is preceded.

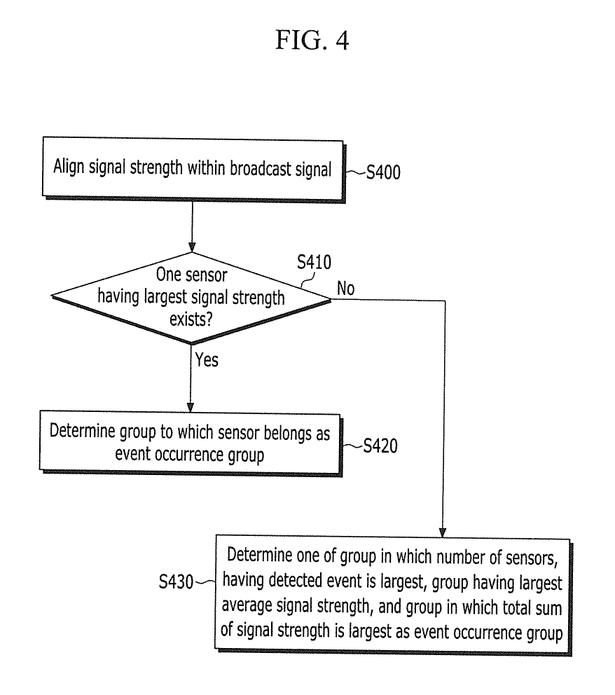

FIG. 4 is a flowchart illustrating a method of determining a group in which an event from an unauthorized AP occurs according to an exemplary embodiment of the present invention.

Referring to FIG. 4, the sensor 10 aligns strength of a signal that is received from an unauthorized AP that is included within a received broadcast signal and a transmitted broadcast signal (S400).

The management server 300 determines whether one sensor having largest signal strength exists (S410), and if one sensor having largest signal strength exists, the management server 300 determines a group to which the sensor belongs as an event occurrence group (S420). For example, when strength of a signal that is included in a broadcast signal of a sensor that is located at a first floor is largest, it may be determined that a corresponding event has occurred at the first floor. If one sensor having largest signal strength does not exist, i.e., if at least two sensors having largest signal strength exist, the management server 300 may determine one of a group in which the number of event detection sensors is largest, a group having largest average signal strength, and a group in which the total sum of signal strength is largest as an event occurrence group (S430).

Thereafter, in a situation in which an event is not terminated, when a sensor in charge stops to operate, a method of changing a sensor will be described. For better comprehension and ease of description, a case in which the sensor 10 belonging to the group 100 is a sensor in charge will be described.

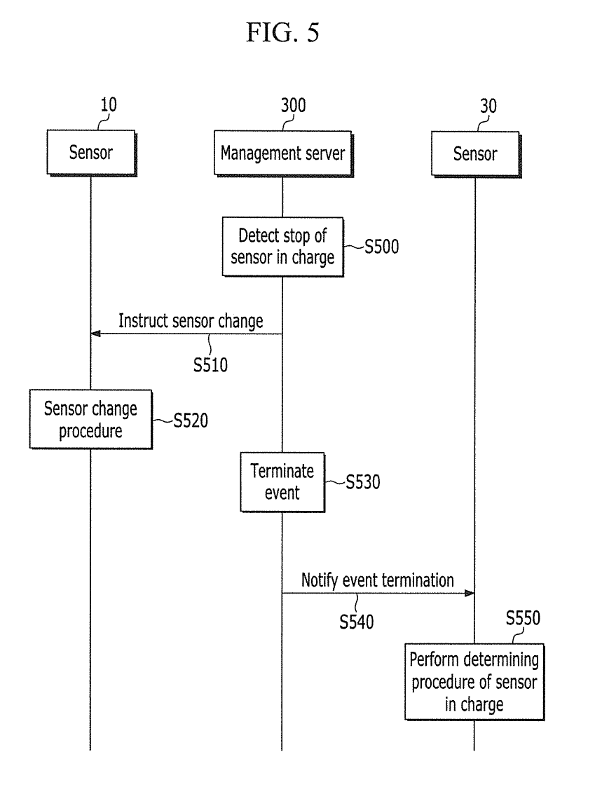

FIG. 5 is a flowchart illustrating a method of changing a sensor according to an exemplary embodiment of the present invention.

Referring to FIG. 5, the management server 300 detects that the sensor in charge 10, having charged a specific event has stopped to operate (S500).

The management server 300 instructs a sensor change to other sensors 11, 12, and 13 of a group to which the sensor in charge 10 belongs (S510), and the sensors 11, 12, and 13 perform a sensor change procedure (S520). For example, in the sensors 11, 12, and 13, when a sensor, having detected a corresponding event exists, the sensor may be a new sensor in charge. In the sensors 11, 12, and 13, when at least two sensors, having detected a corresponding event exist, the management server 300 may determine a new sensor in charge according to an event detection time or strength of a signal that is received from an unauthorized AP. For this purpose, sensors, having detected a corresponding event should manage strength of a signal that is received from an unauthorized AP, and the sensors 11, 12, and 13 may previously set a priority of a new sensor in charge according to strength of a signal.

In a group to which the sensor in charge 10 belongs, when a sensor to charge a corresponding event does not exist, the management server 300 terminates the corresponding event (S530) and notifies sensors 30, 31, 32, and 33 of the other group 200 of event termination (S540). Accordingly, the sensors 30, 31, 32, and 33 of the other group 200 newly perform a determining procedure of a sensor in charge (S550). For example, as described with reference to FIG. 3, a process of event detection, broadcast signal transmission/reception, and determination of a sensor in charge may be performed.

Thereafter, a method of estimating a distance between a sensor and an unauthorized AP will be described.

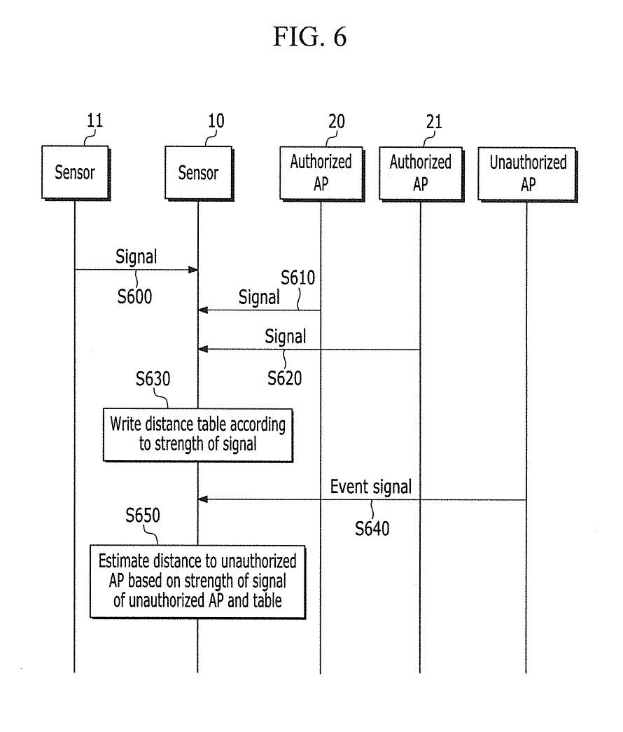

FIG. 6 is a flowchart illustrating a method of estimating a distance according to an exemplary embodiment of the present invention.

Referring to FIG. 6, the sensor 10 receives a signal from other sensors 11, 12, and 13 within the group 100 and authorized APs 20, 21, 22, and 23 within a group (S600, S610, and S620) and writes a distance table according to strength of the received signal (S630). A process of steps S600 to S630 may be repeatedly performed several times. This is because strength of a signal may be changed according to a communication environment, a time, and an obstacle within a group at the same distance. Therefore, the sensor 10 may write and store a distance table of various time zones.

When the sensor 10 receives an event signal from an unauthorized AP (S640), the sensor 10 estimates a distance to the unauthorized AP using strength of a signal of the unauthorized AP and a previously stored distance table (S650). When a distance table of various time zones is previously stored, the sensor 10 may estimate a distance to the unauthorized AP using a distance table corresponding to a reception time of an event signal from the unauthorized AP.

Although not shown in the drawing, the sensor 10 may transmit a distance table and a distance to the unauthorized AP to the management server 300.

When communication with the management server 300 is disconnected, the sensor may perform a self-interception function. That is, in a situation in which communication with the management server 300 is disconnected, when a new event is detected, the sensor stores the detected event and executes event interception, as needed. Simultaneously, the sensor periodically attempts a reconnection to the management server 300, and when communication with the management server 300 is restored, the sensor reports stored events to the management server 300.

The foregoing exemplary embodiment of the present invention may not only be embodied through an apparatus and a method, but may also be embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A wireless invasion prevention system, comprising:
a first group comprising at least one first sensor and at least one first authorized wireless Local Area Network (LAN) device;
a second group comprising at least one second sensor and at least one second authorized wireless LAN device; and
a management server that manages the at least one first sensor and the at least one second sensor,
wherein the first sensor detects event occurrence from an unauthorized wireless LAN device and transmits a first broadcast signal of the event occurrence to the remaining first sensors within the first group and the at least one second sensor.

2. The wireless invasion prevention system of claim 1, wherein the first sensor detects the event occurrence using a Medium Access Control (MAC) address that is included in a signal that is received from the unauthorized wireless LAN device.

3. The wireless invasion prevention system of claim 1, wherein the first sensor comprises:
a transmitting and receiving unit that transmits the first broadcast signal and that receives a second broadcast signal of an event that has occurred from the unauthorized wireless LAN device from at least one of the remaining first sensors and the at least one second sensor; and
a sensor-in-charge determining unit that compares the first broadcast signal and the second broadcast signal and that determines a sensor in charge of the event.

4. The wireless invasion prevention system of claim 3, wherein the first broadcast signal or the second broadcast signal comprises at least one of identification information of the first sensor or the second sensor, strength of a signal that is received from the unauthorized wireless LAN device, a detection time point of event occurrence, and an MAC address and an event kind of the unauthorized wireless LAN device.

5. The wireless invasion prevention system of claim 4, wherein the sensor-in-charge determining unit determines a sensor in charge based on at least one of strength of the signal, the number of sensors, having detected the same event within a group, and the detection time point.

6. The wireless invasion prevention system of claim 4, wherein the first sensor further comprises a group determining unit that determines an event occurrence group based on at least one of strength of a signal that is received from the unauthorized wireless LAN device or the number of sensors, having detected the same event within a group.

7. The wireless invasion prevention system of claim 3, wherein the first sensor further comprises a distance estimation unit that estimates a distance between the first sensor and the unauthorized wireless LAN device based on strength of a signal that is received from the at least one first authorized wireless LAN device.

8. The wireless invasion prevention system of claim 7, wherein the distance estimation unit stores at least one distance table according to strength of a signal that is received from the at least one first authorized wireless LAN device and estimates a distance between the first sensor and the unauthorized wireless LAN device using strength of a signal that is received from the unauthorized wireless LAN device and the distance table.

9. The wireless invasion prevention system of claim 3, wherein the first sensor further comprises a self-interception unit that self-detects and intercepts occurrence of an event, when communication with the management server is disconnected.

10. The wireless invasion prevention system of claim 3, wherein the management server instructs to change a sensor in charge to the remaining sensors, when detecting that operation of the sensor in charge is stopped.

11. The wireless invasion prevention system of claim 3, wherein the first sensor determines a new sensor in charge according to strength of a signal that is received from the unauthorized wireless LAN device or a detection time point of event occurrence, when operation of the sensor in charge is stopped.

12. A sensor, comprising:
an event detection unit that detects event occurrence from an unauthorized wireless Local Area Network (LAN) device;
a transmitting and receiving unit that transmits a first broadcast signal of the event occurrence to other sensors and that receives a second broadcast signal of the event occurrence from the other sensors;
a sensor-in-charge determining unit that compares the first broadcast signal and the second broadcast signal to determine a sensor in charge to intercept an event; and
an event interception unit that intercepts the event.

13. The sensor of claim 12, wherein the first broadcast signal or the second broadcast signal comprises at least one of identification information of a sensor that transmits the first broadcast signal or the second broadcast signal, strength of a signal that is received from the unauthorized wireless LAN device, a detection time point of event occurrence, and a Medium Access Control (MAC) address and an event kind of the unauthorized wireless LAN device.

14. The sensor of claim 13, wherein the sensor belongs to a predetermined group that is separated on space, and
the sensor-in-charge determining unit determines a sensor in charge based on at least one of strength of the signal, the number of sensors, having detected the same event within a group, and the detection time point.

15. The sensor of claim 13, wherein the sensor belongs to a predetermined group that is separated on space, and
the sensor further comprises a group determining unit that determines an event occurrence group based on at least one of strength of the signal or the number of sensors, having detected the same event within a group.

16. The sensor of claim 12, further comprising a distance estimation unit that estimates a distance between the sensor and the unauthorized wireless LAN device based on strength of a signal that is received from at least one authorized wireless LAN device and strength of a signal that is received from an unauthorized wireless LAN device.
